(19) United States
(12) Patent Application Publication
(10) Pub. No.: US 2025/0097922 A1
(43) Pub. Date: Mar. 20, 2025

(54) APPARATUS AND METHOD FOR AVOIDING INTERFERENCE FOR IN-DEVICE COEXISTENCE

(71) Applicant: Huawei Technologies Co., Ltd., Shenzhen (CN)

(72) Inventors: Jagdeep Singh Ahluwalia, Reading (GB); Haibo Xu, Beijing (CN)

(21) Appl. No.: 18/960,868

(22) Filed: Nov. 26, 2024

Related U.S. Application Data
(63) Continuation of application No. PCT/CN2022/095794, filed on May 28, 2022.

(51) Int. Cl. H04W 72/0453; H04W 72/12; H04W 72/541; H04W 76/20

(52) U.S. Cl. CPC H04W 72/0453; H04W 72/12; H04W 72/541; H04W 76/20

(57) ABSTRACT

A user device is configured to transmit and receive signals to and from a network device over a first range of frequencies and implement one or more diverse radio techniques across at least part of the first range, and configured to: receive a request to indicate whether any frequency ranges in the first range are affected by interference between signals of the techniques; and send an indication of one or more frequency ranges in the first range affected by interference between signals of one or more of the diverse radio techniques, the one or more frequency ranges being sub-sets of the first range having a frequency range less than a range of a carrier frequency.

### CROSS-REFERENCE TO RELATED APPLICATIONS

This application is a continuation of International Application No. PCT/CN2022/095794, filed on May 28, 2022, the disclosure of which is hereby incorporated by reference in its entirety.

### TECHNICAL FIELD

This disclosure relates to data transmission in a communications network, in particular to avoiding interference between signals from one or more diverse radio techniques used in user devices such as smartphones.

### BACKGROUND

With increased usage of wireless technologies and services, handheld devices are increasingly equipped with multiple radio transceivers for diverse radio techniques, such as Long Term Evolution (LTE), New Radio (NR), Global Positioning System (GPS), WiFi and Bluetooth. As a result of this, and due to more frequency bands being introduced for both NR and LTE, in-device coexistence (IDC) has become a serious problem due to the proximity of multiple radio transceivers within the same device, as illustrated in FIG. 1. Device 100 accommodates transceivers 101-106 for multiple diverse radio techniques. Transceivers 101 and 102 transmit and receive signals for NR using antenna 107, transceivers 103 and 104 transmit and receive signals for GPS using antenna 108, and transceivers 105 and 106 transmit and receive signals for WiFi and Bluetooth using antenna 109. For some frequency bands, concurrent operations of these multiple diverse radio techniques working in adjacent or sub-harmonic frequencies can result in significant IDC interference that cannot be eliminated by filtering. Therefore, signalling mechanisms and procedures have been introduced to attempt to solve this IDC issue with help from the network.

Previously defined solutions, for example using frequency division multiplexing (FDM), are generally aimed at switching the entire LTE or NR frequency away from the Industrial, Scientific and Medical (ISM) radio frequency (RF) band.

FDM solutions are applicable to all scenarios as long as an alternate carrier frequency is available. In some network deployments, however, using FDM-based solutions to resolve IDC interference problems is not possible or desirable.

In some situations, all available frequency carriers may be impacted by ISM traffic, the user device may be in an area with only one frequency deployment, or the user device may not have good channel quality in the alternative frequencies. In such cases, it can be beneficial to keep the user device in the current frequency and use a Time Division Multiplexing (TDM) based solution.

The IDC interference becomes even more complex when the different frequencies from diverse radio techniques are inter-modulated. A transmitter of NR operating on a Frequency Range 1 (FR1) band (FR1 being below 7.125 GHz for 5G NR), for example, band n41. can interfere with a receiver of WiFi operating on a 2.5G band and vice-versa. As 5 GHz in FR1 and 60 GHz in Frequency Range 2 (FR2) (being above 24.250 GHz for 5G NR) have been allocated as ISM bands, transmitters and/or receivers operating on these bands and those operating on the ISM band will interfere with each other.

It is desirable to develop an improved method of reporting which frequencies are affected by interference so that appropriate actions can be taken by the network, for example to avoid these frequencies, or to use TDM techniques for transmission and reception among different diverse radio techniques implemented by a device.

### SUMMARY

According to one aspect, there is provided a network device in a communications network, the network device being configured to transmit and receive signals to and from a user device in the communications network over a first range of frequencies, wherein signals of one or more diverse radio techniques are carried across at least part of the first range of frequencies, the network device being configured to: send a request to the user device to indicate whether any frequency ranges in the first range of frequencies are affected by interference between signals of one or more of the diverse radio techniques; and receive from the user device an indication of one or more frequency ranges in the first range of frequencies that are affected by interference between signals of one or more of the diverse radio techniques, wherein the one or more frequency ranges are respective sub-sets of the first range of frequencies, each respective sub-set having a frequency range that is less than a range of a carrier frequency of the first range of frequencies.

This may allow the network device to configure the user device to report a more granular indication of frequencies affected by interference at different levels, which can allow the network to take appropriate actions to solve in-device coexistence issues. Alternatively, the user device may request for a TDM pattern to be used that defines a scheduling period for data transmission or reception and/or unscheduled periods of one of the diverse radio techniques, where another of the diverse radio techniques may perform data transmission or reception.

The network device may be configured to: provide an indication of a candidate affected frequency range of the first range of frequencies to the user device; and receive from the user device the indication of the one or more frequency ranges. This may allow the network device to configure the user device to report frequencies affected by interference within the candidate affected frequency range.

At least one of the one or more frequency ranges may be part of the candidate affected frequency range. At least one of the one or more frequency ranges may be respective sub-sets of the candidate affected frequency range, each respective sub-set having a frequency range that is less than a range of a carrier frequency of the candidate affected frequency range. This may allow the network device to configure the user device to report a more granular indication of frequencies affected by interference within the candidate affected frequency range at different levels.

The network device may be configured to provide the indication of the candidate affected frequency range to the user device as an indication of an absolute radio frequency channel number (ARFCN) of a central frequency of the candidate affected frequency range and a bandwidth of the candidate affected frequency range. This may be a convenient way of providing the frequency range to the user device.

The network device may be configured to provide the indication of the candidate affected frequency range to the user device as an indication of an absolute radio frequency channel number of the start of the candidate affected frequency range and an absolute radio frequency channel number of the end of the candidate affected frequency range. This may be an alternative convenient way of providing the frequency range to the user device.

The network device may be configured to receive the indication of the one or more frequency ranges as an identification of one or more affected bandwidth parts of the first range of frequencies. The network device may be configured to receive the indication of the one or more frequency ranges as an identification of one or more affected bandwidth parts of the candidate affected frequency range. This may allow the network device to be informed of the affected bandwidth parts, so that only actually affected bandwidth parts may be avoided.

The candidate affected frequency range may be a serving frequency and the network device may be configured to send an indication of an absolute radio frequency channel number of a central frequency of the candidate affected frequency range and an indication of one or more bandwidth part identifiers of the candidate affected frequency range to the user device. This may be a convenient way of providing the frequency range to the user device.

The candidate affected frequency range may be a non-serving frequency and the network device may be configured to send one or more of the following to the user device: an indication of an absolute radio frequency channel number of a central frequency of the candidate affected frequency range, an absolute radio frequency channel number of Point A, a subcarrier spacing, and bandwidth part information for each bandwidth part of the candidate affected frequency range. This may be a convenient way of providing the frequency range to the user device.

The network device may be configured to receive the indication of the one or more frequency ranges as an identification of one or more affected physical resource blocks of the first range of frequencies. The network device may be configured to receive the indication of the one or more frequency ranges as an identification of one or more affected physical resource blocks of the candidate affected frequency range. This may allow the network device to be informed of the affected physical resource blocks, so that only actually affected physical resource blocks may be avoided.

The candidate affected frequency range may be a serving frequency and the network device may be configured to send an absolute radio frequency channel number of a central frequency of the candidate affected frequency range to the user device. This may be a convenient way of providing the frequency range to the user device.

The candidate affected frequency range may be a non-serving frequency and the network device may be configured to send one or more of the following to the user device: an absolute radio frequency channel number of a central frequency of the candidate affected frequency range, an absolute radio frequency channel number of Point A, and a subcarrier spacing. This may be a convenient way of providing the frequency range to the user device.

The network device may be configured to receive the identification of the one or more affected physical resource blocks as a bitmap, a start index and a number of affected physical resource blocks, or a start index and an end index of the affected physical resource blocks. This may allow the network device to determine which physical resource blocks are affected.

The network device may be further configured to receive from the user device an indication of one or more additional affected frequency ranges, the one or more additional affected frequency ranges being outside of the candidate affected frequency range. This may allow affected frequency ranges that are outside of the candidate range causing in-device coexistence interference to be reported to the network device. This may also include the case where no candidate affected frequency range is provided by the network device. In this case, the user device is able to report the one or more affected frequency ranges based on an indication configured by the network device for the user device to report any affected frequency ranges in the first range of frequencies (i.e. in the whole frequency range used by the device, such as the 5G spectrum).

The network device may be configured to receive from the user device an indication of one or more time division multiplexing patterns for scheduling data in one or more of an uplink direction and a downlink direction to be used between one or more of the diverse radio techniques implemented by the user device. The network device may be configured to receive from the user device an indication of a suggested gap pattern to be used between one or more of the diverse radio techniques implemented by the user device. The network device may be configured to receive the indication of the one or more time division multiplexing patterns or the suggested gap pattern for one or more frequency ranges of the first range of frequencies of the first frequency range (for example, for FR1 and FR2). Based on the indication of the one or more time divisional multiplexing patterns received from the user device, the network device may be configured to apply a scheduling restriction or configure discontinuous reception or a gap pattern for communication between the network device and the user device such that communications are not sent using the one or more affected frequency ranges in either the uplink or downlink direction. This may allow subframes affected by interference due to in-device coexistence to be avoided. If the user device is unable to perform accurate measurements on certain frequencies with the configured gap pattern, the user device can indicate this to network device. Additionally, the user device may request reconfiguration of the existing gap pattern with a shorter periodicity to have more opportunities to perform the measurements.

The network device may be configured to provide the indication of the candidate affected frequency range to the user device as one or more individual candidate affected frequency ranges or as a common frequency range covering multiple candidate affected frequency ranges. The network device may be configured to provide the indication of the candidate affected frequency range to the user device as one or more absolute radio frequency channel numbers and individual bandwidths or as a common bandwidth covering multiple candidate affected frequency ranges. This may allow the network device to send the indication of the candidate affected frequency range as an absolute radio frequency channel number and an individual bandwidth or as a common bandwidth covering multiple candidate affected frequency ranges.

Based on the indication of the one or more frequency ranges received from the user device, the network device may be configured to apply a scheduling restriction for communication between the network device and the user device such that communications are not sent using the one or more frequency ranges. This may allow frequencies affected by interference due to in-device coexistence to be avoided.

Based on the indication of the one or more frequency ranges received from the user device, the network device may be configured to configure the user device for additional inter-frequency measurements. This may be a convenient implementation

Based on the indication of the one or more frequency ranges received from the user device, the network device may be configured to move the user device to a preferred serving frequency. This may allow frequency ranges affected by interference to be avoided.

The one or more diverse radio techniques may comprise one or more of Long Term Evolution, New Radio, WiFi, Wireless Local Area Network, Global Positioning System and Bluetooth. This may allow the approach to be used to mitigate interference from in-device coexistence in modern devices such as smartphones.

The network device may be a base station. The network device may be a gNodeB.

This may allow the network device to be used in a telecommunications network.

The gNodeB may comprise a centralized unit, one or more distributed units and an interface connecting the centralized unit with the one or more distributed units, the network device being configured to include an indication of the scheduling restriction (or alternatively or additionally a discontinuous reception pattern and/or a gap pattern) in a UE CONTEXT MODIFICATION REQUEST message or a UE CONTEXT MODIFICATION RESPONSE message sent on the interface. This may allow the gNodeB to communicate scheduling restrictions on the F1 interface where the gNB has a split architecture.

The network device may be configured to receive the indication of the one or more frequency ranges from the user device in a radio resource control (RRC) message. This may allow for compatibility with existing procedures.

The network device may be a master node configured to communicate with the user device and a secondary node in the communications network under a multi-radio access technology dual connectivity scheme. This may allow for compatibility with existing procedures.

The network device may be configured to: receive information relating to the candidate affected frequency range from the secondary node; and send information relating to the one or more frequency ranges to the secondary node. This may allow the secondary node to be informed of frequency ranges affected by interference due to in-device coexistence.

The network device may be configured to receive one or more of the following from a neighbouring node in the communications network: information about the candidate affected frequency range and one or more frequency ranges that are affected by interference between signals of one or more of the diverse radio techniques implemented by the user device for cells controlled by the neighbouring node. This may allow the network device to be informed of affected frequencies for nearby nodes.

The network device may be a source node in the communications network and the network device may be configured to perform a handover procedure to transfer a communications session from the source node to a target node in the communications network, wherein the network device is configured to transfer the communications session to a frequency that is not part of the one or more frequency ranges. This may allow the approach to be implemented in a communications network where the user device is mobile to allow frequency ranges affected by interference to be avoided.

The network device may be a source node in the communications network and the network device may be configured to perform a handover or cell selection procedure to transfer a communications session from the source node to a target node in the communications network, wherein the network device is configured to send information about the one or more frequency ranges (and optionally a suggested TDM pattern) received from the user device to the target node during the handover or cell reselection procedure. This may allow the approach to be implemented in a communications network where the user device is mobile.

According to another aspect there is provided a method for implementation at a network device in a communications network, the network device being capable of transmitting and receiving signals to and from a user device in the communications network over a first range of frequencies, wherein signals of one or more diverse radio techniques are carried across at least part of the first range of frequencies, the method comprising: sending a request to the user device to indicate whether any frequency ranges in the first range of frequencies are affected by interference between signals of one or more of the diverse radio techniques; and receiving from the user device an indication of one or more frequency ranges in the first range of frequencies that are affected by interference between signals of one or more of the diverse radio techniques, wherein the one or more frequency ranges are respective sub-sets of the first range of frequencies, each respective sub-set having a frequency range that is less than a range of a carrier frequency of the first range of frequencies.

This method may allow the network device to configure the user device to report a more granular indication of affected frequencies at different levels, which can allow the network to take appropriate actions to solve in-device coexistence issues.

According to another aspect there is provided a user device in a communications network, the user device being configured to transmit and receive signals to and from a network device in the communications network over a first range of frequencies and implement one or more diverse radio techniques across at least part of the first range of frequencies and being configured to: receive a request from the network device to indicate whether any frequency ranges in the first range of frequencies are affected by interference between signals of one or more of the diverse radio techniques; and send to the network device an indication of one or more frequency ranges in the first range of frequencies that are affected by interference between signals of one or more of the diverse radio techniques, wherein the one or more frequency ranges are respective sub-sets of the first range of frequencies, each respective sub-set having a frequency range that is less than a range of a carrier frequency of the first range of frequencies.

This may allow the user device to report a more granular indication of affected frequencies at different levels, which can allow the network to take appropriate actions to solve in-device coexistence issues. Alternatively, the user device may request for a TDM pattern to be used that defines a scheduling period for data transmission or reception and/or unscheduled periods of one of the diverse radio techniques, where another of the diverse radio techniques may perform data transmission or reception.

The user device may be configured to receive an indication of a candidate affected frequency range of the first range of frequencies from the network device and send to the network device the indication of the one or more frequency ranges. This may allow the network device to configure the user device to report frequencies affected by interference within the candidate affected frequency range.

At least one of the one or more frequency ranges may be part of the candidate affected frequency range. At least one of the one or more frequency ranges may be respective sub-sets of the candidate affected frequency range, each respective sub-set having a frequency range that is less than a range of a carrier frequency of the candidate affected frequency range. This may allow the user device to be configured by the network device to report a more granular indication of frequencies affected by interference within the candidate affected frequency range at different levels.

The user device may be configured to receive the indication of the candidate affected frequency range from the network device as an indication of an absolute radio frequency channel number of a central frequency of the candidate affected frequency range, and a respective bandwidth of the candidate affected frequency range or a common bandwidth of the candidate affected frequency range. This may be a convenient way for the user device to be provided with the candidate affected frequency range.

The user device may be configured to receive the indication of the candidate affected frequency range from the network device as an indication of an absolute radio frequency channel number of the start of the candidate affected frequency range and an absolute radio frequency channel number of the end of the candidate affected frequency range. This may be another convenient way for the user device to be provided with the candidate affected frequency range.

The user device may be configured to send the indication of the one or more frequency ranges as an identification of one or more affected bandwidth parts of the first range of frequencies. The user device may be configured to send the indication of the one or more frequency ranges as an identification of one or more affected bandwidth parts of the candidate affected frequency range. This may allow the user device to inform the network device of the affected bandwidth parts, so that only actually affected bandwidth parts may be avoided.

The candidate affected frequency range may be a serving frequency and the user device may be configured to receive an indication of an absolute radio frequency channel number of a central frequency of the candidate affected frequency range and an indication of one or more bandwidth part identifiers of the candidate affected frequency range from the network device. This may allow the user device to identify the candidate affected frequency range.

The candidate affected frequency range may be a non-serving frequency and the user device may be configured to receive one or more of the following from the network device: an indication of an absolute radio frequency channel number of a central frequency of the candidate affected frequency range, an absolute radio frequency channel number of Point A, a subcarrier spacing, and bandwidth part information for each bandwidth part of the candidate affected frequency range. This may allow the user device to identify the candidate affected frequency range.

The user device may be configured to send the indication of the one or more frequency ranges as an identification of one or more affected physical resource blocks of the first range of frequencies. The user device may be configured to send the indication of the one or more frequency ranges as an identification of one or more affected physical resource blocks of the candidate affected frequency range. This may allow the user device to inform the network device of the affected physical resource blocks, so that only actually affected physical resource blocks may be avoided.

The candidate affected frequency range may be a serving frequency and the user device may be configured to receive an absolute radio frequency channel number of a central frequency of the candidate affected frequency range from the network device. This may allow the user device to identify the candidate affected frequency range.

The candidate affected frequency range may be a non-serving frequency and the user device may be configured to receive one or more of the following from the network device: an absolute radio frequency channel number of a central frequency of the candidate affected frequency range, an absolute radio frequency channel number of Point A, and a subcarrier spacing. This may allow the user device to identify the candidate affected frequency range.

The user device may be configured to send the identification of the one or more affected physical resource blocks as a bitmap, a start index and a number of affected physical resource blocks, or a start index and an end index of the affected physical resource blocks. This may allow the user device to inform the network device of the affected physical resource blocks.

The user device may be further configured to send to the network device an indication of one or more additional affected frequency ranges, the one or more additional affected frequency ranges being outside of the candidate affected frequency. This may allow the user device to report affected frequency ranges that are outside of the candidate range indicated by the network device causing in-device coexistence interference.

The user device may be configured to send to the network device an indication of one or more time division multiplexing patterns for scheduling data in one or more of an uplink direction and a downlink direction to be used between one or more of the diverse radio techniques implemented by the user device. The user device may be configured to send to the network device an indication of a suggested gap pattern to be used between one or more of the diverse radio techniques implemented by the user device. The user device may be configured to send the indication of the one or more time division multiplexing patterns or suggested gap pattern for one or more frequency ranges of the first range of frequencies (for example, for FR1 and FR2 frequencies). If the user device is unable to perform accurate measurements on certain frequencies with a gap pattern configured by the user device, the user device may indicate this to network device. Additionally, the user device may request reconfiguration of an existing gap pattern with a shorter periodicity to have more opportunities to perform the measurements.

The user device may be configured to receive the indication of the candidate affected frequency range from the network device as an absolute radio frequency channel number for a central frequency and an individual bandwidth for one or more individual candidate affected frequency ranges or an absolute radio frequency channel number for a central frequency and a common bandwidth covering multiple candidate affected frequency ranges. This may allow the user device to receive the candidate affected frequency range as an individual range or a common range covering multiple candidate affected frequency ranges.

The one or more diverse radio techniques may comprise one or more of Long Term Evolution, New Radio, WiFi, Wireless Local Area Network, Global Positioning System and Bluetooth. This may allow the approach to be used to mitigate interference from in-device coexistence in modern devices such as smartphones.

The user device may be configured to send the indication of the one or more frequency ranges to the network device in a radio resource control message. This may allow for compatibility with existing procedures.

One frequency range of the one or more frequency ranges may be due to interference between New Radio transmissions from the user device and non-3GPP receptions at the user device. One frequency range of the one or more frequency ranges may be due to interference between non-3GPP transmissions from the user device and New Radio receptions at the user device. Interference from these techniques may affect different frequency ranges within the candidate affected frequency range. Therefore this may allow the affected frequency ranges to be reported to the network device separately.

The network device may be a master node and the user device may be further configured to communicate with a secondary node in the communications network under a multi-radio access technology dual connectivity scheme. This may allow for compatibility with existing processes.

The user device may be configured to: receive information relating to the candidate affected frequency range from the master node; and send information relating to the one or more frequency ranges to the secondary node. This may allow the user device to inform the secondary node of frequency ranges affected by interference due to in-device coexistence.

The user device may be configured to send information relating to the one or more frequency ranges to the secondary node via a signalling radio bearer type 3. This may be a convenient implementation.

The user device may be configured to receive transmissions from the secondary node subject to a scheduling restriction applied by the secondary node in dependence on the one or more frequency ranges. This may allow communications between the user device and the secondary node to avoid frequency ranges affected by interference due to in-device coexistence.

According to another aspect there is provided a method for implementation at a user device in communications network, the user device being capable of transmitting and receiving signals to and from a network device in the communications network over a first range of frequencies and implementing one or more diverse radio techniques across at least part of the first range of frequencies, the method comprising: receiving a request from the network device to indicate whether any frequency ranges in the first range of frequencies are affected by interference between signals of one or more of the diverse radio techniques; and sending to the network device an indication of one or more frequency ranges in the first range of frequencies that are affected by interference between signals of one or more of the diverse radio techniques implemented by the user device, wherein the one or more frequency ranges are respective sub-sets of the first range of frequencies, each respective sub-set having a frequency range that is less than a range of a carrier frequency of the first range of frequencies.

This method may allow the user device to report a more granular indication of affected frequencies at different levels, which can allow the network to take appropriate actions to solve in-device coexistence issues.

According to a further aspect, there is provided a computer-readable storage medium having stored thereon computer-readable instructions that, when executed at a computer system, cause the computer system to perform the method set out above. The computer system may comprise one or more processors. The computer-readable storage medium may be a non-transitory computer-readable storage medium.

### BRIEF DESCRIPTION OF THE DRAWINGS

The present disclosure will now be described by way of example with reference to the accompanying drawings. In the drawings:

FIG. 1 schematically illustrates in-device coexistence in a user device comprising transceivers for multiple diverse radio frequency techniques, including WiFi, Bluetooth, New Radio and Global Positioning System.

FIG. 2 schematically illustrates an embodiment of the present invention where the affected frequency is reported to the network device by the user device as one or more actually affected frequency ranges.

FIG. 3 schematically illustrates an embodiment of the present invention where the affected frequency is reported to the network device by the user device as one or more actually affected bandwidth parts (BWPs).

FIG. 4 schematically illustrates an embodiment of the present invention where the affected frequency is reported to the network device by the user device as one or more actually affected physical resource blocks (PRBs).

FIG. 5 shows an exemplary communication flow between the devices in a network where a scheduling restriction is implemented based on the reported actually affected frequency range(s).

FIG. 6 shows an exemplary communication flow between the devices in a network where a network device configures a user device to use a preferred serving frequency.

FIG. 7(a) shows an exemplary communication flow between the devices in a network where a network device can receive interference information from a neighbouring node in the communications network.

FIG. 7(b) shows another exemplary communication flow between the devices in a network where a network device can receive interference information from a neighbouring node in the communications network.

FIG. 8 shows an embodiment where a network device performs a handover procedure to transfer a communications session from a source node to a target node, where the communications session is transferred to a frequency that is not part of the one or more affected frequency ranges.

FIG. 9 shows an exemplary communication flow between the devices in a network where the network device is a gNB with a split architecture between a central unit (CU) and a distributed unit (DU).

FIG. 10 shows an exemplary communication flow between a user device, a master node and a secondary node in a multi-radio access technology dual connectivity scheme.

FIG. 11 shows a further exemplary communication flow between a user device, a master node and a secondary node in a multi-radio access technology dual connectivity scheme where the user device communicates with the secondary node via a radio signal bearer type 3.

FIG. 12 shows an example of an RRC reconfiguration procedure between a user device and a network device and a UE Assistance Information message sent from the user device to the network device.

FIG. 13(a) schematically illustrates examples of suggested TDM patterns sent to the network device by the user device.

FIG. 13(b) schematically illustrates examples of a discontinuous reception pattern and a scheduling restriction for the user device that is configured by the network device.

FIG. 14(a) schematically illustrates an example of a suggested gap pattern sent to the network device by the user device.

FIG. 14(b) schematically illustrates an example of a gap pattern for the user device that is configured by the network device.

FIG. 15(a) schematically illustrates examples of suggested gap patterns sent to the network device by the user device for different frequencies.

FIG. 15(b) schematically illustrates examples of gap patterns for the user device that are configured by the network device for different frequencies.

FIG. 16 shows a flow chart of the steps of an example of a method for implementation at a network device in accordance with embodiments of the present invention.

FIG. 17 shows a flow chart of the steps of an example of a method for implementation at a user device in accordance with embodiments of the present invention.

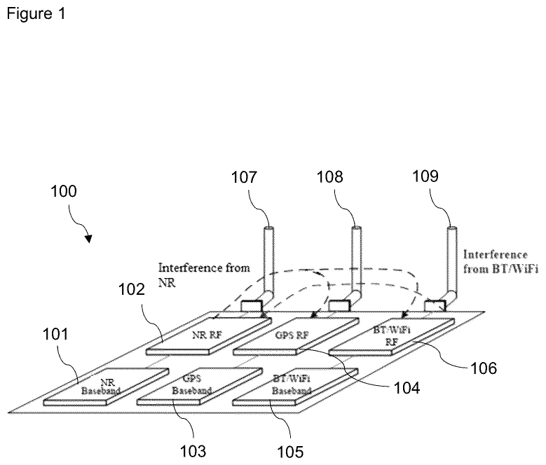

### DETAILED DESCRIPTION OF ILLUSTRATIVE EMBODIMENTS

A communications network generally comprises multiple nodes. Each node is a connection point in the communications network and can act as an endpoint for data transmission or redistribution. Each node may be, for example, a gNodeB (gNB).

A Next Generation Radio Access Network (NG-RAN) may comprise multiple gNBs. Each gNB may comprise multiple computing entities, such as a Centralized Unit (CU) and multiple Distributed Units (DU). The CU may communicate with a DU via an F1 interface, which is an interface that connects a gNB CU to a gNB DU.

Two gNBs in the network may be interconnected with each other by means of an Xn network interface, which is a network interface between the NG-RAN nodes of the NG-RAN. The gNBs are also connected by means of Next Generation (NG) network interfaces to the 5G Core Network (5GC), more specifically to the Access and Mobility Management Function (AMF) by means of a control plane interface (NG-C) between the NG-RAN and the 5GC and to the User Plane Function (UPF) by means of a user plane interface (NG-U) between the NG-RAN and the 5GC.

Each network node may comprise at least one processor and at least one memory. The memory stores in a non-transient way code that is executable by the processor(s) to implement the node in the manner described herein. The nodes may also comprise a transceiver for transmitting and receiving data. The communications network is preferably a wireless network.

One or more of the gNBs in the network may communicate with a user equipment device (UE), such as a mobile phone, laptop or tablet. The UE may be configured to implement one or more diverse radio techniques. The diverse radio techniques may comprise one or more of Long Term Evolution (LTE), New Radio (NR), WiFi, Wireless Local Area Network (W-LAN), Global Positioning System (GPS) and Bluetooth, or any other common techniques used in modern devices.

The UE may comprise at least one processor and at least one memory. The memory stores in a non-transient way code that is executable by the processor(s) to implement the device in the manner described herein. The UE may also comprise a transceiver for transmitting and receiving data.

The UE can communicate with the gNB over a range of frequencies using one or more of the diverse radio techniques. The range of frequencies may comprise frequencies in the radio frequency part of the electromagnetic spectrum, which corresponds to frequencies of approximately 3 Hz to 3,000 GHz. The range of frequencies may comprise frequencies in the 5G spectrum, from approximately 700 MHz to 80 GHz. The one or more diverse radio techniques may each use at least part of this range of frequencies to send signals between the UE and the gNB. The part(s) of the frequency range used by each technique may not be adjacent and/or contiguous frequency ranges, and in some cases may not be the same for each time slot (for example where the technique uses frequency hopping). There may be interference between signals of one or more of the diverse radio techniques implemented by the UE across one or more frequency ranges in the range of frequencies across which the UE is configured to generally operate. The interference may be due to respective signals sent or received using two of more of the diverse radio techniques implemented by the user device, or may be due to interference between different frequencies for a single technique, such as different frequencies used by 5G NR.

The methods for IDC avoidance described herein include a mechanism for a network node to configure the UE to report a more granular indication of affected frequencies at different levels, which can allow the network to take appropriate action to mitigate interference due to IDC.

The examples described below detail the information that can be configured by the gNB for the UE to report the frequencies affected by IDC interference at a more granular level, as opposed to just reporting the carrier frequency that has IDC interference (the carrier frequency being the frequency of a carrier wave, that is modulated to transmit signals). A carrier frequency may also be referred to as a frequency band. A frequency band or carrier frequency is a specific range of frequencies in the radio frequency (RF) spectrum. Each band has defined upper and lower limits. Herein, the one or more frequency ranges that are actually affected by interference from IDC are smaller ranges than the frequency range of a carrier or frequency band.

The gNB provides a configuration to the UE to allow it to report the frequencies affected by IDC interference. Generally, the gNB may configure the UE to report the affected frequencies using a radio resource control (RRC) reconfiguration procedure, whereby one or more RRC Reconfiguration messages are sent from the gNB to the UE. As part of this procedure, as will be described in more detail below, the gNB sends a request for the UE to indicate whether any frequency ranges in the first range of frequencies are affected by interference between signals of one or more of the diverse radio techniques. In some implementations, the gNB can send the UE an indication of a candidate affected frequency range for which the UE is requested to report the frequency ranges affected by IDC issues. This information, optionally including the indication of the candidate affected frequency range, may be contained within an OtherConfig information element (IE) in an RRC Reconfiguration message sent from the gNB to the UE.

When IDC is detected by the UE, it can report the actually affected frequency range at a level such as the affected bandwidth part(s), part of an affected bandwidth part, part of the affected carrier frequency range, or a range of affected physical resource blocks of the candidate affected frequency range, and/or of a range outside of the candidate range. The UE may send the indication of the actually affected frequencies as part of a UE Assistance Information message sent from the UE to the gNB. This is an RRC message that provides information from the UE, for example of any preferred configuration or reporting of interference issues.

As will be described in more detail below, based on the information of the affected frequency range received from the UE, for example as part of the UE assistance information, the gNB can temporarily apply a scheduling restriction, configure the UE for additional inter-frequency measurements, or move the UE to a preferred serving frequency.

Various possible solutions for the configuration and reporting will now be described.

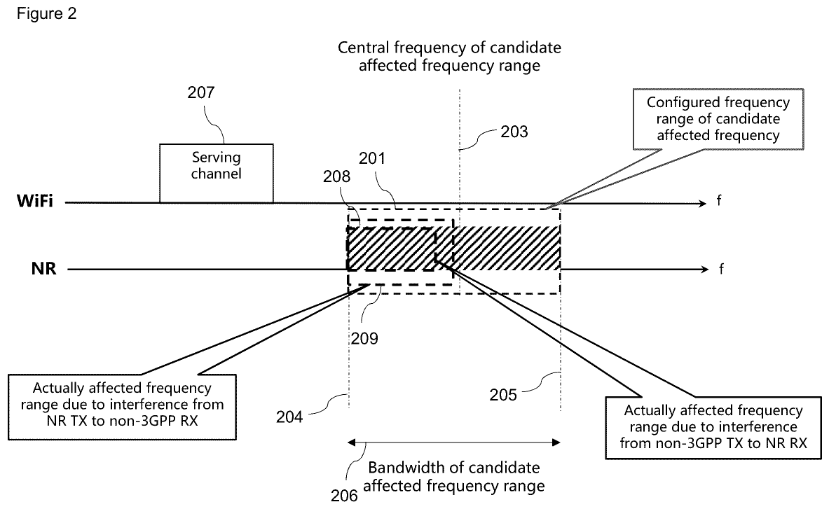

A first embodiment is schematically illustrated in FIG. 2. In this example, the UE is configured to communicate with the gNB using WiFi and NR and there is interference across a range of frequencies between WiFi and NR transmissions and receptions by the UE. The gNB provides an enhanced IDC configuration to the UE. In this example, the IDC configuration includes an indication of a candidate affected frequency range, shown at 201. The candidate affected frequency range is a specific frequency range for which the UE is requested to report any IDC issues. The candidate frequency range may be a single frequency range or may be a wider common frequency range covering multiple individual candidate affected frequency ranges. In other examples, the gNB may send a general request to the UE to report any interference issues across the whole range of frequencies across which the UE is configured to operate.

In this example, the candidate affected frequency range 201 is a single frequency range. The central frequency of the candidate affected frequency range is shown at 203. The starting frequency of the candidate affected frequency range is shown at 204 and the end frequency of the candidate affected frequency range is shown at 205. The bandwidth of the candidate affected frequency range is shown at 206. The bandwidth 206 is equal to the difference between the starting frequency 204 and the end frequency 205.

The gNB may send the indication of the candidate affected frequency range to the UE on the current serving channel having a frequency range as indicated at 207. This may be sent to the UE using either NR or WiFi.

In one embodiment, the gNB may provide the indication of the candidate affected frequency range to the UE as an indication of an absolute radio frequency channel number (ARFCN) of the central frequency of the candidate affected frequency range and the bandwidth of the candidate affected frequency range.

An ARFCN is a code that specifies a pair of reference frequencies used for transmission and reception in a radio system. In a frequency division duplex (FDD) system, one ARFCN is required for downlink and another for uplink (as downlink and uplink frequencies are different), while for a time division duplex (TDD) system, one ARFCN is enough, as the downlink and uplink frequency remains the same.

In another implementation, the gNB may provide the indication of the candidate affected frequency range to the user device as an indication of an ARFCN of the start of the candidate affected frequency range 204 and an ARFCN of the end of the candidate affected frequency range 205.

In this embodiment, in response to receiving an indication of the candidate affected frequency range 201, the UE can report one or more frequency ranges of the candidate affected frequency that are actually affected by interference between signals of one or more of the diverse radio techniques implemented by the UE.

In FIG. 2, frequency ranges 208 and 209 are affected by interference due to IDC. These affected frequency ranges may be detected using any suitable method. The frequency ranges 208, 209 are respective sub-sets of the candidate affected frequency range 201. Each respective sub-set 208, 209 has a frequency range that is less than a range of a carrier frequency of the candidate affected frequency range 201.

The one of more affected frequency ranges may be different sub-ranges of the candidate affected frequency range that are due to interference between transmitted or receive signals from one of more of the diverse radio techniques implemented by the UE.

In this particular example, the frequency range 208 is due to interference between non-3GPP (for example, WiFi) transmissions from the UE and NR receptions (RX) at the UE. The frequency range 209 is due to interference between NR transmissions (TX) from the UE and non-3GPP receptions at the UE. The frequency ranges 208 and 209 are different sub-ranges of the candidate affected frequency 201. Therefore, using this technique, these different sub-ranges of the candidate affected frequency range can be individually reported to the gNB.

Therefore, for each candidate affected frequency range (single or multiple), if the UE detects an IDC issue within the frequency range configured by the gNB (i.e. the candidate affected frequency range), the UE reports the actually affected frequency range to the gNB and can do this at a granularity less than a range of a carrier frequency of the candidate affected frequency range.

The UE can report the one or more actually affected frequency ranges to the gNB using a number of different methods.

In one embodiment, the UE reports the ARFCN of the central frequency of the respective affected frequency range and the bandwidth of the respective affected frequency range. In another embodiment, the UE reports the ARFCN of the start of the respective affected frequency range and the ARFCN of the end of the respective affected frequency range to the gNB. These terms have the same meaning as those shown and described for the candidate affected frequency range in FIG. 2. From this, the gNB may determine the frequency range to be avoided during subsequent communications.

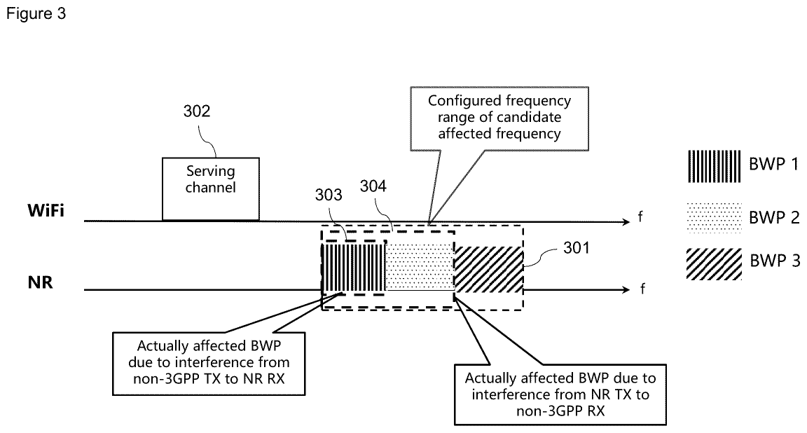

FIG. 3 shows an alternative embodiment where the UE can report the identity of one or more actually affected bandwidth parts (BWPs) to the gNB.

A BWP is a contiguous set of physical resource blocks (PRBs) on a given carrier. One PRB spans 12 subcarriers. Subcarriers may have different spacings, but for example with a 15-kHz subcarrier spacing, one PRB corresponds to 180 kHz. These PRBs are selected from a contiguous subset of the common resource blocks for a given numerology (u). Each BWP defined for a numerology can have the following parameters: subcarrier spacing, symbol duration and cyclic prefix (CP) length.

In the example shown in FIG. 3, the candidate affected frequency range is shown at 301. Three separate BWPs (BWP 1, BWP 2 and BWP 3) within the candidate affected frequency range are shown.

In response to receiving the indication of the candidate affected frequency range 301, the UE reports the one or more BWPs of the candidate affected frequency that are actually affected by interference to the gNB.

The gNB may send the indication of the candidate affected frequency range of the UE on the current serving channel having a frequency range as indicated at 302. This may be sent to the UE using either NR or WiFi.

To enable the UE to report the identity of one or more affected BWPs, the gNB can configure the UE with the following information for the candidate affected frequency 301.

Where the candidate affected frequency is a serving frequency, the gNB can send an indication of the ARFCN of the central frequency of the candidate affected frequency range and an indication of one or more BWP identifiers (IDs) of the candidate affected frequency range (i.e. identifiers for the BWPs of the candidate affected frequency range) to the UE. In the example shown in FIG. 3, the candidate affected frequency range comprises BWPs 1-3. The gNB therefore sends an indication of the ARFCN of the central frequency of the candidate affected frequency range 301 and BWP IDs for BWPs 1-3 to the UE.

Where the candidate affected frequency range is a non-serving frequency, the gNB can send one or more of the following to the UE: an indication of the ARFCN of the central frequency of the candidate affected frequency range, the ARFCN of Point A, a subcarrier spacing (SCS), and BWP information for each bandwidth part of the candidate affected frequency range. The BWP information may include, for example an identifier of a BWP, a location and bandwidth of a BWP and the subcarrier spacing of the BWP. ‘Point A’ is a common reference point for all resource grids in the frequency domain. It is the center of the subcarrier o of common resource block o of the lowest resource grid. Point A can be outside of the carrier bandwidth.

For the non-serving frequency, the UE can determine the frequency domain location and bandwidth of the candidate affected BWPs based on the ARFCN of Point A, the subcarrier spacing, and BWP information for each bandwidth part of the candidate affected frequency range, including the location and bandwidth of a BWP and a SCS) of the BWP provided by the gNB.

For each candidate affected frequency range, if the UE detects an IDC issue within the one or more BWPs configured by the gNB (i.e. the one or more BWPs in the candidate affected frequency range indicated by the gNB), the UE can report the identities of the actually affected BWPs to the gNB.

The information that the UE reports to the gNB for each affected frequency range may include the ARFCN of the central frequency of each affected BWP and/or the BWP ID(s) of one or more actually affected BWPs.

As shown in FIG. 3, the affected BWPs 303, 304 are respective sub-sets of the candidate affected frequency range 301 and each respective sub-set 303, 304 has a frequency range that is less than a range of a carrier frequency of the candidate affected frequency range 301; in this case comprising one or more BWPs of the candidate affected frequency range.

The affected BWPs 303, 304 are different sub-ranges of the candidate affected frequency range that are due to interference between transmitted or received signals from one of more of the diverse radio techniques implemented by the UE. In this particular example, the frequency range 303, comprising BWP 1, is due to interference between non-3GPP (e.g. WiFi) transmissions from the UE and NR receptions at the UE. The frequency range 304, comprising BWPs 1 and 2, is due to interference between NR transmissions from the UE and non-3GPP receptions at the UE. The frequency ranges 303 and 304 are different sub-ranges of the candidate affected frequency 301. Therefore, using this technique, these different sub-ranges of the candidate affected frequency range can be individually reported.

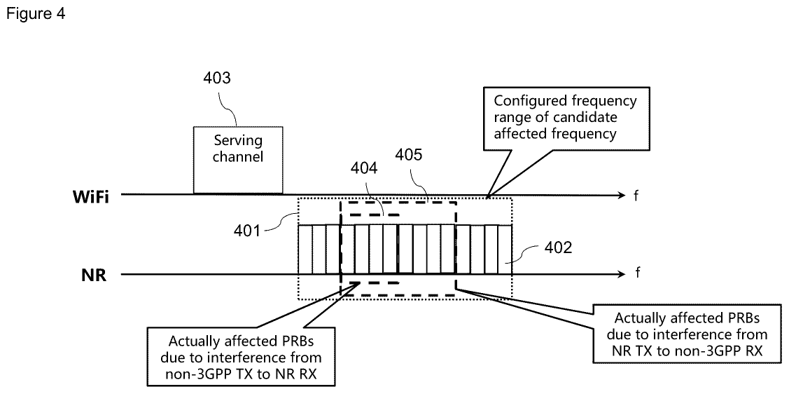

In a further embodiment, as schematically illustrated in FIG. 4, the UE can report the actually affected physical resource blocks (PRBs) of the candidate affected frequency range, shown at 401, to the gNB. The candidate affected frequency range 401 comprises one or more PRBs. In this example, the candidate affected frequency range 401 comprises multiple PRBs, one of which is shown at 402.

In order to enable the UE to report the actually affected PRB(s), the gNB can configure the UE with the following information for the candidate affected frequency range 401.

The gNB may send the indication of the candidate affected frequency range 401 to the UE on the current serving channel having a frequency range as indicated at 403. This may be sent to the UE using either NR or WiFi.

Where the candidate affected frequency range 401 is a serving frequency, the gNB can send the ARFCN of the central frequency of the candidate affected frequency range plus the bandwidth of the candidate affected frequency range to the UE, or alternatively an ARFCN of the start and the end frequencies of the candidate affected frequency range.

Where the candidate affected frequency range 401 is a non-serving frequency, the gNB can send the ARFCN of the central frequency of the candidate affected frequency range, the ARFCN of Point A, and a SCS. For a non-serving frequency, the UE can determine the frequency domain location based on the ARFCN of Point A, and a SCS from the gNB.

For each candidate affected frequency range, if the UE detects an IDC issue within the carrier bandwidth configured by the gNB, the UE can report the actually affected PRB(s) of the carrier to the gNB.

For each actually affected frequency range, the UE can send the ARFCN of the central frequency of the respective frequency range and an indication of the actually affected PRBs.

The indication of the one or more actually affected PRBs can be sent to the gNB as a bitmap, a start index for the affected PRBs and a number of affected PRBs, or a start index for the affected PRBs and an end index for the affected PRBs.

In this particular example, the affected PRBs at 404 are due to interference between non-3GPP transmissions from the UE and NR receptions at the UE. The affected PRBs at 405 are due to interference between NR transmissions from the UE and non-3GPP receptions at the UE. The frequency ranges 404 and 405 are different sub-ranges of the candidate affected frequency 401. Therefore, using this technique, these different sub-ranges of the candidate affected frequency range can be individually reported.

In a further embodiment, the UE can also report information for non-configured frequency ranges which are outside of the candidate affected frequency range indicated to the UE by the gNB as part of the IDC configuration procedure.

In this embodiment, the gNB may configure the candidate affected frequency range(s) as described in any of the above embodiments. If the UE detects an IDC issue outside of the candidate affected frequency range(s) configured by the gNB, the UE can report these frequency ranges or combination of frequency ranges to the gNB. In other words, affected frequency range(s) which have not been configured by the network (i.e. that are not part of the candidate affected frequency range sent to the UE) can be reported if the UE experiences IDC interference problems on these frequencies or combination of frequencies.

In the above example, the UE can therefore indicate to the gNB one or more frequency ranges that are actually affected by interference between signals sent and received by the UE on particular frequencies at a granularity that is less than a range of a carrier frequency of the candidate affected frequency range, rather than by indicating the entire carrier frequency.

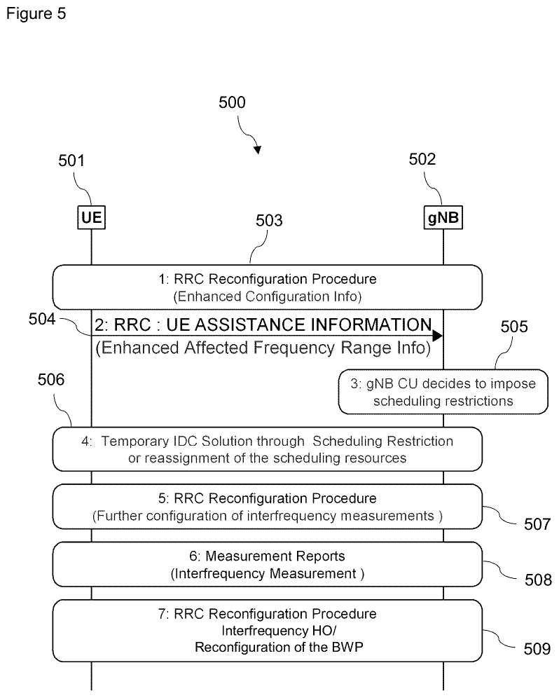

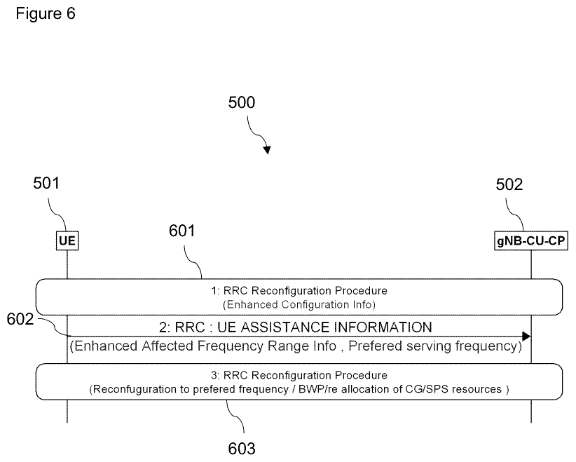

Based on the information indicating the actually affected frequency range(s) received from the UE, for example in an RRC UE Assistance Information message, the gNB may perform operations including, but not limited to, applying a scheduling restriction for communication between the gNB and the UE, such that communications are not sent using the one or more affected frequency ranges, moving the UE to a preferred serving frequency, and configuring the UE for additional inter-frequency measurements, as will be described in more detail below with reference to FIGS. 5 and 6.

As illustrated in the communication flow of FIG. 5, a network 500 comprises a UE 501 and a gNB 502. The gNB 502 can permanently (i.e. for the remainder of the communication session between the UE and that gNB) or temporarily apply a scheduling restriction so that the gNB does not schedule signals on the actually affected frequency ranges. The gNB can also further configure the UE for additional inter-frequency measurements.

At 503 in FIG. 5, the gNB 502 initiates an RRC reconfiguration procedure and the gNB 502 sends the enhanced configuration information, optionally including the indication of the candidate affected frequency range, to the UE 501. As part of the RRC reconfiguration procedure, the indication of the candidate affected frequency range may be contained within an OtherConfig information element (IE) in an RRC Reconfiguration message sent from the gNB to the UE.

At 504, the UE 501 sends the enhanced affected frequency range information in an RRC message, such as an RRC UE ASSISTANCE INFORMATION message in this example.

At 505, the gNB 502 decides to impose scheduling restrictions. At 506, the gNB temporarily implements an IDC solution and does not schedule the UE on the affected frequency range(s). At 507, the gNB 502 further configures interfrequency measurements using an RRC reconfiguration procedure.

At 508, the UE 501 reports the interfrequency measurements and the affected frequency range(s) to the gNB 502.

At 509, the gNB 502 implements a further RRC reconfiguration procedure and can perform an interfrequency handover (HO) and reconfigure the frequency range (for example, the BWPs) on which signals are sent to the UE subsequently.

As illustrated in the communication flow of FIG. 6, based on the information of the affected frequency range(s) received from the UE in an RRC UE ASSISTANCE INFORMATION message, that could additionally include preferred serving frequency (which is seen as the strongest serving frequency by the UE), the gNB can directly switch the UE to its preferred serving frequency.

At 601 in FIG. 6, the gNB 502 initiates an RRC reconfiguration procedure, including sending the enhanced configuration information, optionally including the indication of the candidate affected frequency range, to the UE 501.

At 602, the UE 501 sends the enhanced affected frequency range information and an indication of a preferred serving frequency (which may be determined based at least in part on the one or more affected frequency range(s)) in an RRC message, such as an RRC UE ASSISTANCE INFORMATION message in this example.

At 603, the gNB 502 implements an RRC reconfiguration procedure and reconfigures the UE to its preferred serving frequency (for example, preferred BWPs) for subsequent communications, along with allocation of cell group (CG) or semi-persistent scheduling (SPS) resources. A benefit of this approach is that the gNB can straight away reconfigure the frequency and/or resources away from the affected frequency range(s) without any further measurement.

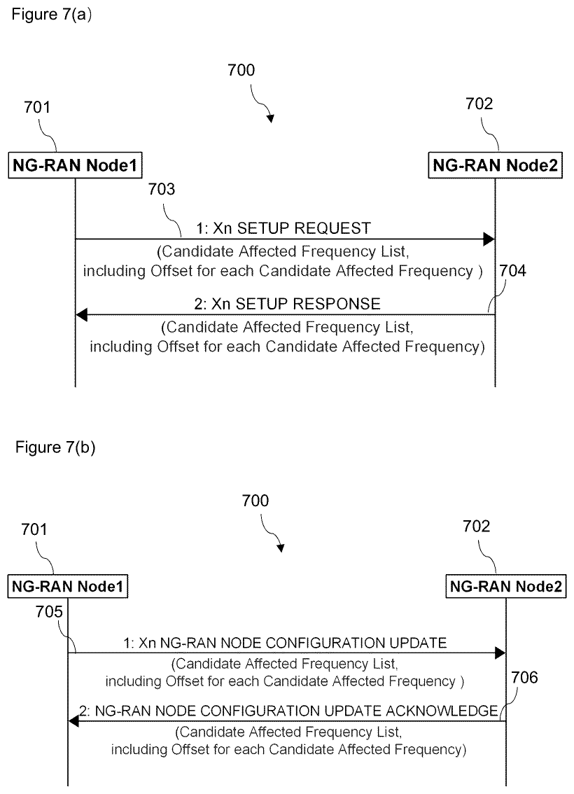

In some implementations, a gNB may communicate with other gNBs in the communications network. FIG. 7 shows an exemplary communication flow for a network 700 comprising two neighboring next generation radio access network (NG-RAN) nodes 701 and 702.

The gNB can provide information about the candidate affected frequency range and part(s) of the affected frequency band as described in the above examples for the cells it controls to a neighboring gNB over the Xn or X2 interface (the X2 interface being an interface between two eNodeBs in a 4G system).

A node can use the ARFCNs of the reference Point A and other offsets or parameters, such as the offset from the start of the carrier, the number of resource blocks (carrier bandwidth), and the SCS, including an offset from the start of the carrier for each candidate affected frequency range, to determine the location of the affected frequency band to be exchanged between the nodes.

Different neighboring gNBs may have different candidate affected frequency ranges. Therefore, the serving gNB can combine these multiple ranges into one single range to cover each candidate frequency range (from the serving gNB and each neighboring gNB) before sending the list to the UE.

This information can be exchanged in an X2 SETUP REQUEST/RESPONSE message or an Xn SETUP REQUEST/RESPONSE message.

In the example shown in FIG. 7(a), at 703, Node1 701 sends an Xn SETUP REQUEST message to Node2 702 on the Xn interface between the nodes. This message includes a candidate affected frequency list, including an offset from the start of the carrier for each candidate affected frequency range.

At 704, Node2 702 sends an Xn SETUP RESPONSE message to Node1 701. This message includes a candidate affected frequency list, including offset for each candidate affected frequency.

The information may also be exchanged in an X2 NG-RAN NODE CONFIGURATION UPDATE REQUEST/RESPONSE message or Xn NG-RAN NODE CONFIGURATION UPDATE REQUEST REQUEST/ACKNOWLEDGE message.

In the example shown in FIG. 7(b), at 705, Node1 701 sends an Xn NG-RAN CONFIGURATION UPDATE message to Node2 702 on the Xn interface between the nodes. This message includes a candidate affected frequency list, including an offset from the start of the carrier for each candidate affected frequency range.

At 706, Node2 702 sends an NG-RAN NODE CONFIGURATION UPDATE ACKNOWLEDGE message to Node1 701. This message includes a candidate affected frequency list, including an offset from the start of the carrier for each candidate affected frequency.

The configuration for the gNB to indicate the candidate affected frequency range to the UE and for the UE to report the affected frequency range(s) to the gNB may use any of the methods described above with reference to FIGS. 2-4 (for example, by indicating the ARFCN of the central frequency and the bandwidth of the candidate affected frequency range or affected frequency range).

In a further implementation, the gNB may be a source node in the communications network. The source gNB can perform a handover procedure to transfer a communications session between the source gNB and a UE from the source gNB to a target gNB in the network. Knowing the one or more frequency ranges that are affected by interference, the source gNB can transfer the communications session to a frequency that is not part of the one or more affected frequency ranges.

In another example, the source gNB may be configured to perform a cell selection procedure to transfer a communications session from the source gNB to a target gNB and can send information about the affected frequency range(s) received from the UE to the target gNB during the cell reselection procedure.

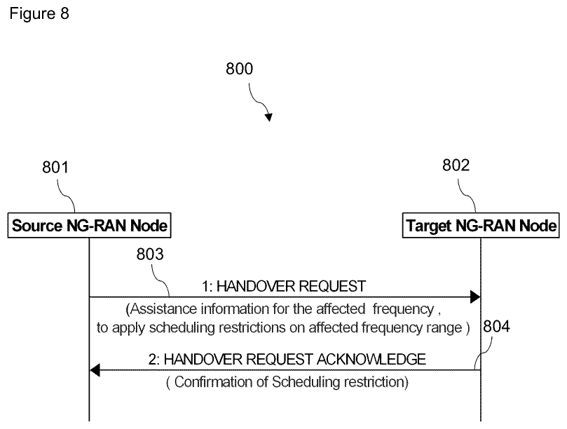

FIG. 8 shows one example in a network 800 comprising a source NG-RAN node 801 and a target NG-RAN node 802.

At 803, the source node 801 sends a HANDOVER REQUEST message to the target node 802. This message comprises assistance information that indicates the one or more frequency ranges affected by interference from IDC that were received by the source node from the UE. This information can be used by the target node to apply scheduling restrictions on the affected frequency range(s) when communicating with the UE once handover is complete.

At 804, the target node 802 send the source node 801 a HANDOVER REQUEST ACKNOWLEDGE message, with confirmation of the scheduling restriction.

Once handover is complete, the target node 802 can then communicate with the UE whilst implementing a scheduling restriction for the one or more affected frequency ranges that it was informed of by the source node.

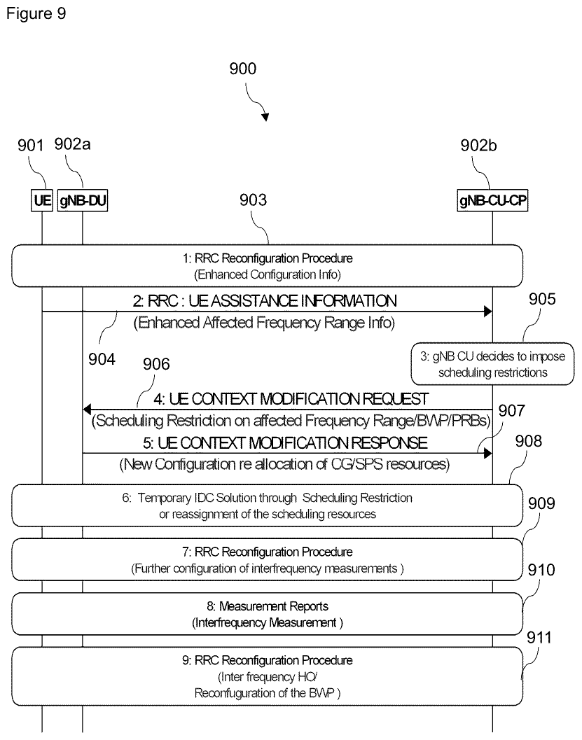

FIG. 9 shows another exemplary communication flow for a network 900 where the gNB has a split architecture. In this example, a UE 901 communicates with a gNB comprising a Distributed Unit (DU) 902a and a Centralized Unit (CU) 902b. The DU 902a communicates with the CU 902b via an F1 interface. In particular, the communication takes place between the gNB-DU 902a and a control plane (CP) of the gNB CU 902b.

At 903, the UE 901 and gNB-DU 902a and gNB-CU-CP 902b undergo an RRC reconfiguration procedure, including sending the enhanced configuration information with the indication of the candidate affected frequency range to the UE 901.

At 904, the UE 901 sends the enhanced affected frequency range information in an RRC message, such as an RRC UE ASSISTANCE INFORMATION message in this example.

At 905, the gNB-CU-CP 902b decides to impose scheduling restrictions.

At 906, the gNB-CU-CP 902b sends an UE CONTEXT MODIFICATION REQUEST message to the gNB-DU on the F1 interface. A UE CONTEXT MODIFICATION REQUEST message is a message sent from the gNB-CU-CP to the gNB-DU requesting modification of the UE Context stored at the gNB. Generally, the UE Context may include information such as the Security Key, UE Radio Capability, UE Security Capabilities and configuration parameters for configuring the radio interface protocol layers. In this implementation, the UE CONTEXT MODIFICATION REQUEST message includes a scheduling restriction for the one or more actually affected frequency ranges (for example, BWPs or PRBs).

At 907, the gNB-DU 902a sends an UE CONTEXT MODIFICATION RESPONSE message to the gNB-CU 902b on the F1 interface in response to the UE CONTEXT MODIFICATION REQUEST message, including a new configuration regarding allocation of cell group (CG) or semi-persistent scheduling (SPS) resources.

At 908, the gNB implements a temporary IDC solution through scheduling restriction on the affected frequencies or by reassignment of the scheduling resources.

At 909, an RRC reconfiguration procedure takes place between the gNB and the UE where the UE is further configured for interfrequency measurements.

At 910, the UE 901 reports its interfrequency measurements to the gNB and at 911 the gNB implements a further RRC reconfiguration procedure for interfrequency handover (HO) to further reconfigure the frequency range (for example, BWPs) on which signals are sent to the UE subsequently.

The indication of the scheduling restriction may therefore be included in a UE CONTEXT MODIFICATION REQUEST message or a UE CONTEXT MODIFICATION RESPONSE message sent on the F1 interface between the gNB-CU and gNB-DU.

In some embodiments, the gNB may be one of multiple nodes in the network and may act as a master node (MN) configured to communicate with a UE under a multi-radio access technology dual connectivity (MRDC) scheme.

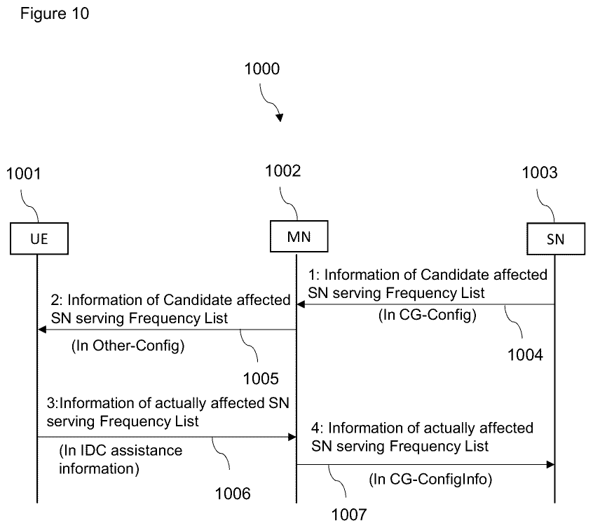

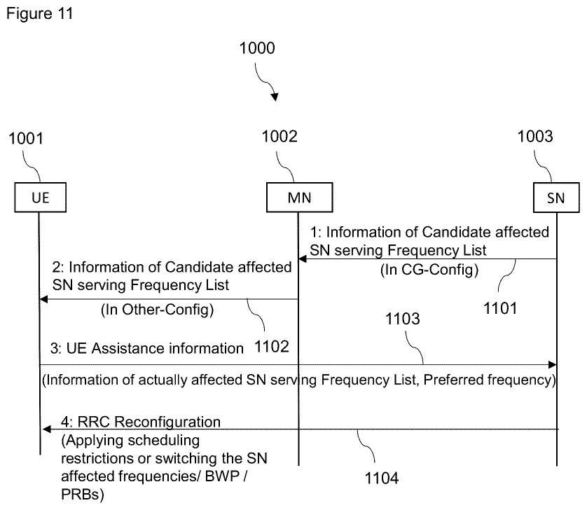

In MRDC, the MN functions as the controlling entity, utilizing a secondary node (SN) that is also configured to communicate with the UE for additional data capacity. Exemplary MRDC configurations include Evolved Universal Terrestrial Radio Access (E-UTRA), New Radio Dual Connectivity (EN-DC), New Radio Dual Connectivity (NR-DC), NG-RAN-E-UTRA Dual Connectivity (NGEN-DC) and New Radio E-UTRA Dual Connectivity (NE-DC). The examples described below with reference to FIGS. 10 and 11 may implement any of these configurations.

As will now be described, the MN can receive information relating to the candidate affected frequency range from the SN. The UE can send information relating to the one or more affected frequency ranges to the SN, either via the MN or via a signalling radio bearer in the network.

FIG. 10 shows an exemplary communication flow for a network 1000 comprising a UE 1001, an MN 1002 and an SN 1003. The UE 1001 is configured to communicate with the MN and the SN under an MRDC scheme.

At 1004, the SN 1003 provides information relating to the candidate affected frequency range of the SN serving frequency to the MN 1002. In this example, the information is provided in a CG-Config information element (IE) of an RRC message. The candidate affected frequency range may be indicated to the UE using any format described above, in particular with reference to FIGS. 2-4 (for example, by indicating the ARFCN of the central frequency and the bandwidth of the candidate affected frequency range or affected frequency range).

At 1005, the MN 1002 provides the information relating to the candidate affected frequency range of the SN serving frequency to the UE 1001. In this example, the information is provided in an Other-Config IE of an RRC message. The MN may alternatively or additionally provide TDM-related information to the SN in an Other-Config IE of an RRC message, as will be described in more detail later.

At 1006, the UE 1001 provides the MN 1002 with information relating to the one or more actually affected frequencies in the candidate affected frequency range. In this example, the information is provided in an IDC Assistance Information IE of an RRC message.

At 1007, the MN 1002 provides the SN 1003 with the information relating to the one or more actually affected frequencies in the candidate affected frequency range. In this example, the information is provided in a CG-ConfigInfo IE of an RRC message.

In an alternative implementation, the UE can send the information relating to the one or more actually affected frequency ranges to the SN 1003 via a signalling radio bearer (SRB) type 3. FIG. 11 shows an exemplary communication flow for network 1000 for this implementation.

Steps 1101 and 1102 are the same as steps 1004 and 1005 respectively described above with reference to FIG. 10.

At 1103 in FIG. 11, the information of the actually affected frequency range(s) in the SN serving frequency list, and optionally a preferred frequency range for communication with the UE, or TDM pattern information, are provided directly to the SN 1003 by the UE 1001 via signalling radio bearer 3 (SRB 3) in the network. SRB3 is an SRB in the network that is used for specific RRC messages when the UE is in Evolved-Universal Terrestrial Radio Access New Radio Dual Connectivity (EN-DC), which may be sent using a dedicated control channel (DCCH) logical channel.

At 1004, information relating to applying scheduling restrictions or switching of the SN affected frequency range(s) (for example, BWP(s) or PRB(s)) is provided to the UE directly on SRB 3.

MN 1002 and SN 1003 may also exchange the information on the actually affected frequency range(s) for coordination about the switching or handover of the SN affected frequency range(s).

The SN 1003 may therefore be configured to, based on the information indicating the actually affected frequency range(s) received from the UE, apply a scheduling restriction or perform switching of the SN affected frequency range(s) (which may be BWPs or PRBs).

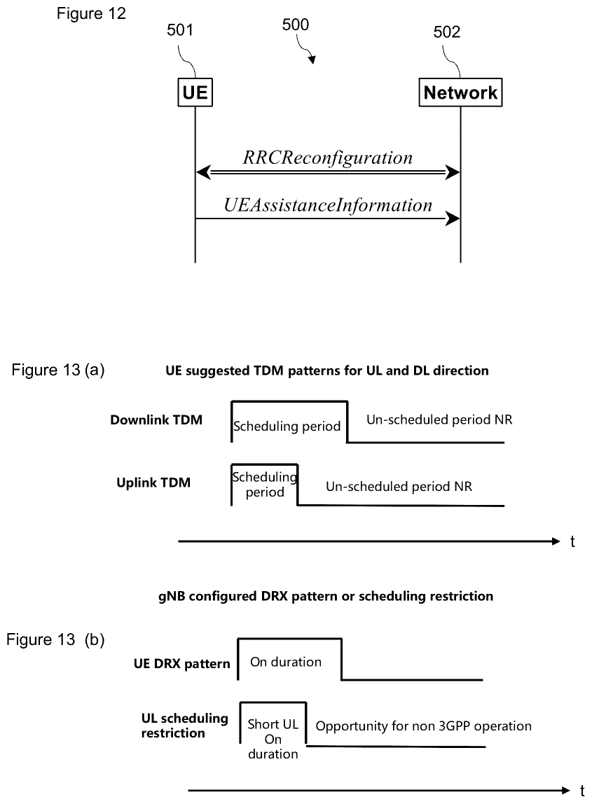

In some embodiments of the present invention, using both standalone and MRDC schemes, the UE may additionally send to the gNB an indication of one or more time division multiplexing (TDM) patterns for scheduling data in one or more of the uplink (UL, from UE to gNB) and downlink (DL, from gNB to UE) directions, or a common TDM pattern for both UL and DL to be used for one or more of the diverse radio techniques. The UE may also send an indication of a suggested gap pattern to be used for one or more of the diverse radio techniques. The UE may send this additional information in an RRC message, such as a UE Assistance Information message, as described above and as illustrated in FIG. 12 between UE 501 and network device (gNB) 502 in network 500. The gNB may then configure the UE to use the suggested TDM pattern(s) and/or the gap pattern(s), or a different TDM pattern or gap pattern.

FIG. 13(a) schematically illustrates examples of DL and UL TDM patterns sent to the gNB 502 by the UE 501. In this example, the UE sends suggested TDM patterns for scheduling data for both the UL and DL directions. The TDM patterns include indications of periods where communications using one of the diverse radio techniques (in this case NR) may be scheduled or unscheduled.

Based on the indication of one or more suggested TDM patterns received from the UE, the gNB may apply a scheduling restriction or configure discontinuous reception (DRX) (see, for example, https://en.wikipedia.org/wiki/Discontinuous_reception) for communication between the gNB and the UE such that communications are not sent using the one or more affected frequency ranges in either the UL or DL direction and communications may be sent using TDM instead.

FIG. 13(b) schematically illustrates a DRX pattern and a scheduling restriction for the UE that is configured by the gNB. This may allow subframes affected by interference due to IDC to be avoided.

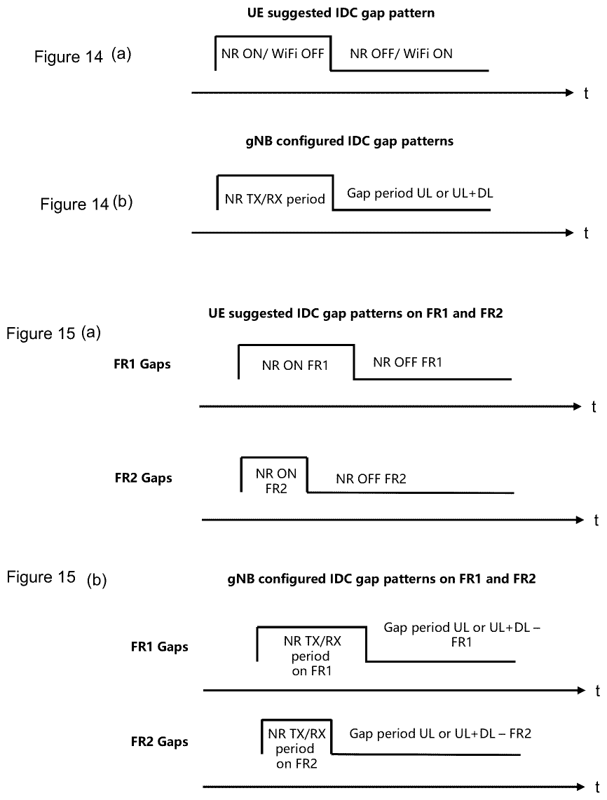

FIG. 14(a) schematically illustrates an example of a suggested gap pattern sent to the gNB 502 by the UE 501. In this example, the UE sends a suggested gap pattern indicating where NR and WiFi should be on or off. This can help to avoid interference between the signals sent and received using NR and WiFi. FIG. 14(b) schematically illustrates the gap pattern configured by the gNB. The gNB can specify a time period to be used for NR transmissions (TX) and receptions (RX) and a gap period for UL (or both UL and DL) where data is not sent (or sent and received) by the UE using NR.

The UE may send the indication of the one or more TDM or gap patterns to the gNB for different frequency ranges. For example, as schematically illustrated in FIG. 15(a), the UE can suggest gap patterns on both FR1 and FR2 used by NR. FIG. 15(b) schematically illustrates the gap patterns configured by the gNB for FR1 and FR2 for NR.

If the UE is unable to perform accurate measurements on certain frequencies with the configured gap pattern, the UE can indicate this to network. Additionally, the UE may request reconfiguration of the existing gap pattern with a shorter periodicity to have more opportunities to perform the measurements.

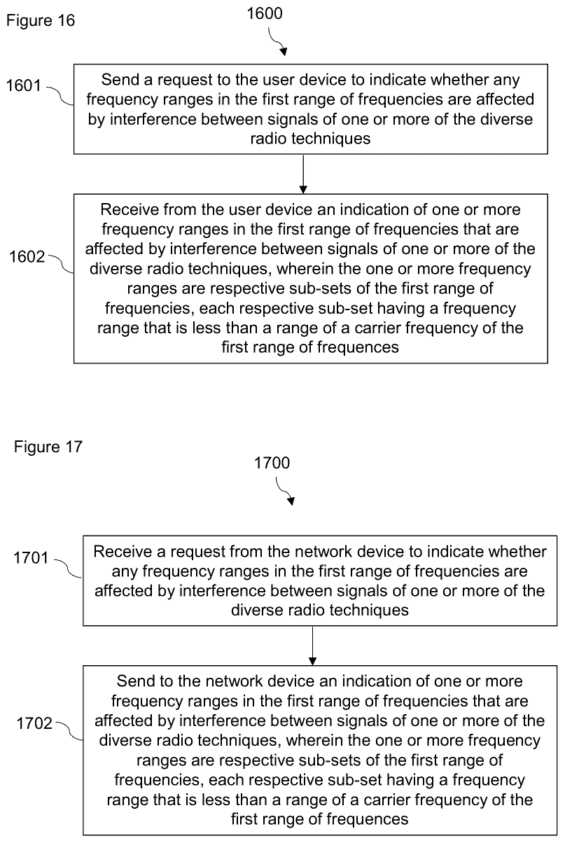

FIG. 16 shows an example of a general method 1600 for implementation at a network device in a communications network in accordance with embodiment of the present invention. The network device is capable of transmitting and receiving signals to and from a user device in the communications network over a first range of frequencies. The user device is capable of implementing one or more diverse radio techniques across at least part of the first range of frequencies. At step 1601, the method comprises sending a request to the user device to indicate whether any frequency ranges in the first range of frequencies are affected by interference between signals of one of more of the diverse radio techniques. At step 1602, the method comprises receiving from the user device an indication of one or more frequency ranges in the first range of frequencies that are affected by interference between signals of one or more of the diverse radio techniques, wherein the one or more frequency ranges are respective sub-sets of the first range of frequencies, each respective sub-set having a frequency range that is less than a range of a carrier frequency of the first range of frequencies.

FIG. 17 shows an example of method 1700 for implementation at a user device in communications network in accordance with embodiments of the present invention. At step 1701, the method comprises receiving a request from the network device to indicate whether any frequency ranges in the first range of frequencies are affected by interference between signals of one of more of the diverse radio techniques. At step 1702, the method comprises sending to the network device an indication of one or more frequency ranges in the first range of frequencies that are affected by interference between signals of one or more of the diverse radio techniques, wherein the one or more frequency ranges are respective sub-sets of the first range of frequencies, each respective sub-set having a frequency range that is less than a range of a carrier frequency of the first range of frequencies.

The methods described herein may therefore be used in a variety of schemes, including those implementing FDM and TDM.

In current IDC FDM solutions, a UE can only report the whole carrier frequency as the affected frequency range, and not the actual affected frequency range at more granular level than the carrier frequency.

By configuring the UE to report the frequencies that are actually affected, at a more granular level such as BWPs and PRBs, this may allow the network to take appropriate action to avoid only the affected frequencies, whilst leaving the unaffected frequencies in the candidate affected frequency range available for use.

Furthermore, in previous methods, the UE can only report for the frequencies requested by the gNB. An affected frequency range which is not indicated by the gNB cannot be reported by the UE. Using the solution described herein, the UE can also report additional frequency ranges or combinations of frequencies causing IDC interference that are outside of the candidate affected frequency range.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

What is claimed is:

1. A user device, comprising:
one or more processors; and
one or more memories coupled to the one or more processors and storing programming instructions for execution by the one or more processors to cause the user device to:
transmit and receive signals to and from a network device over a first range of frequencies;
receive an indication of a candidate affected frequency range in the first range of frequencies from the network device; and
send to the network device an indication of one or more frequency ranges in the first range of frequencies that are affected by interference,
wherein the one or more frequency ranges are sub-sets of the first range of frequencies.

2. The user device as claimed in claim 1, wherein at least one of the one or more frequency ranges is part of the candidate affected frequency range.

3. The user device as claimed in claim 1, wherein the user device is further configured to receive the indication of the candidate affected frequency range an indication of an absolute radio frequency channel number (ARFCN) of a central frequency of the candidate affected frequency range and a bandwidth of the candidate affected frequency range.

4. The user device as claimed in claim 3, wherein the indication of the candidate affected frequency range is contained within an OtherConfig information element (IE) in a radio resource control (RRC) reconfiguration message.

5. The user device as claimed in claim 1, wherein the user device is further configured to send to the network device the indication of the one or more frequency ranges as an indication of an ARFCN of a central frequency of the one or more frequency ranges and a bandwidth of the one or more frequency ranges.

6. The user device as claimed in claim 5, wherein the indication of the one or more frequency ranges is contained within a user equipment device (UE) assistance information message in an RRC message.

7. The user device as claimed in claim 1, wherein the user device is further configured to send to the network device an indication of one or more additional affected frequency ranges, the one or more additional affected frequency ranges being outside of the candidate affected frequency range.

8. The user device as claimed in claim 1, wherein the user device is configured to send to the network device an indication of one or more time division multiplexing patterns for scheduling data in one or more of an uplink direction and a downlink direction.

9. The user device as claimed in claim 1, wherein the user device is configured to implement one or more diverse radio techniques across at least part of the first range of frequencies.

10. A network device, comprising:
one or more processors; and
one or more memories coupled to the one or more processors and storing programming instructions for execution by the one or more processors to cause the network device to:
transmit and receive signals to and from a user device over a first range of frequencies;
send an indication of a candidate affected frequency range in the first range of frequencies to the user device; and
receive from the user device an indication of one or more frequency ranges in the first range of frequencies that are affected by interference,
wherein the one or more frequency ranges are respective sub-sets of the first range of frequencies.

11. The network device as claimed in claim 10, wherein at least one of the one or more frequency ranges is part of the candidate affected frequency range.

12. The network device as claimed in claim 10, wherein the network device is further configured to send the indication of the candidate affected frequency range as an indication of an ARFCN of a central frequency of the candidate affected frequency range and a bandwidth of the candidate affected frequency range.

13. The network device as claimed in claim 12, wherein the indication of the candidate affected frequency range is contained within an OtherConfig IE in an RRC reconfiguration message.

14. The network device as claimed in claim 10, wherein the network device is further configured to receive from the user device the indication of the one or more frequency ranges as an indication of an ARFCN of a central frequency of the one or more frequency ranges and a bandwidth of the one or more frequency ranges.

15. The network device as claimed in claim 14, wherein the indication of the one or more frequency ranges is contained within a UE assistance information message in an RRC message.

16. The network device as claimed in claim 10, wherein the network device is further configured to receive from the user device an indication of one or more additional affected frequency ranges, the one or more additional affected frequency ranges being outside of the candidate affected frequency range.

17. The network device as claimed in claim 10, wherein the network device is configured to receive from the user device an indication of one or more time division multiplexing patterns for scheduling data in one or more of an uplink direction and a downlink direction.

18. A method, comprising:
transmitting and receiving signals to and from a network device over a first range of frequencies;
receiving an indication of a candidate affected frequency range in the first range of frequencies from the network device; and
sending to the network device an indication of one or more frequency ranges in the first range of frequencies that are affected by interference,
wherein the one or more frequency ranges are respective sub-sets of the first range of frequencies.

19. The method as claimed in claim 18, wherein the method comprising:
at least one of the one or more frequency ranges is part of the candidate affected frequency range.

20. The method as claimed in claim 18, wherein the method comprising:
implementing one or more diverse radio techniques across at least part of the first range of frequencies.
